(19) United States
(12) Patent Application Publication
(10) Pub. No.: US 2007/0226054 A1
(43) Pub. Date: Sep. 27, 2007

(54) Coordinated multiple sales promotions

(76) Inventors: Roland Keil, Ubstadt-Weiher (DE); Susanne Georg, Sinsheim (DE); Martin Semmler, Angelbachtal (DE)

Correspondence Address: FISH & RICHARDSON, P.C., PO BOX 1022, MINNEAPOLIS, MN, 55440-1022, US

(21) Appl. No.: 11/387,212

(22) Filed: Mar. 23, 2006

(51) Int. Cl. G06Q 30/00

(52) U.S. Cl. 705/14

(57) ABSTRACT

Electronic sales promotion information is created that includes multiple sales promotion items that may apply to the same product sales transaction, and electronic sales orders are processed using the created electronic sales promotion information. A method of creating sales promotion information includes receiving user-initiated input to generate a sales promotion marketing item and associate the generated marketing item with sales of a selected product. If one or more sales promotion marketing items have been previously associated with sales of the selected product, a user is provided a display of the previously associated marketing items to guide user design of conditions among the newly associated marketing item and the one or more previously associated marketing items. User-designed condition information is received and electronically stored for use in a subsequent computer-executed process.

### TECHNICAL FIELD

This document relates to creating promotional sales marketing items and using them in a product sales transaction process, and creates and uses the marketing items in a way that enables effective management of the marketing items when multiple marketing items apply to the same product sales transaction.

### BACKGROUND

Sales transaction processing computing systems perform various computing processes in connection with a sale of a product. For example, in an internet sales context, a sales transaction processing computing system may receiving information filled out by a user in a web interface, and then perform a sales transaction of computing a price and processing payment by a customer. In addition, point of sale transaction processing systems also perform sales transaction processing in connection with a sale of a product.

Various sales promotions may be designed by a company to encourage additional product sales, sometime from certain customers. For example, there may be various types of discounts provided, for example, bulk discounts or discounts to a target audience for which the seller desires to increase sales. It is very often that multiple different sales promotion programs may be designed that may impact the same sales transaction.

Marketing planning computing systems exist that are used for marketing persons to design promotional sales programs for particular products and particular customer or customer classes. Marketing specialists use these systems to design a sales promotion that may be referred to as a marketing item. Information about the marketing item may be electronically stored so that it may be used in other computer processes, such as a sales order transaction process. Stored sales promotion marketing item information has been used in the computation of a price to charge a customer in a particular sales transaction.

### SUMMARY

Generally, this document relates to creating promotional sales marketing items and using them in a product sales transaction process, and creates and uses the marketing items in a way that enables effective management of the marketing items when multiple marketing items apply to the same product sales transaction.

In one aspect, this document describes a computer-implemented process for creating electronic sales promotion information. The method includes receiving user-initiated input to generate a sales promotion marketing item and associate the generated marketing item with sales of a selected product. If one or more sales promotion marketing items have been previously associated with sales of the selected product, the method includes providing a user display of the previously associated marketing items to guide user design of conditions among the newly associated marketing item and the one or more previously associated marketing items. The method also includes receiving user-designed condition information and electronically storing the received condition information for use in a subsequent computer-executed process.

In various implementations of the method of creating the electronic sales promotion information, one or more of the following additional features may be used. The subsequent computer-executed process may be a pricing process executed in conjunction with a sale of the product. In this case, the newly associated and the one or more previously associated sales promotion marketing items may be of a type that impacts a price that a customer is charged for a product. At least one and in some cases more of the associated sales promotion marketing items may be a sales discount.

The condition information may include an identification of a one of the newly associated and the previously associated marketing items that will serve as a primary marketing item that is attributed the effects of all other of the associated marketing items for purposes of analytical reporting. Additionally or alternatively, the condition information may include information that determines what is to happen when it happens that multiple ones of the associated marketing items are determined during the pricing process to apply to a product sale. Further yet, the condition information may include information that identifies a maximum price discount in an event that multiple ones of the associated marketing items provide a price discount and are determined during the pricing process to apply to a product sale. The condition information may also include information that identifies a discount escalation procedure to be followed in an event that multiple ones of the associated marketing items provide a price discount and are determined during the pricing process to apply to a product sale.

In addition, the method of creating the electronic sales promotion information may also include receiving user-initiated input about the newly associated sales promotion marketing item. This information may include a validity period for the marketing item and applicable products to which the newly associated sales promotion marketing item applies. The user-initiated input about the newly associated sales promotion marketing item may also include an identification of customers for whom the newly associated marketing item applies.

In another aspect, this document describes a computer-implemented process for processing an electronic sales order using electronic sales promotion information. The method includes, in connection with the receipt of electronic information in connection with a sales transaction, determining if any sales promotion marketing items are applicable to the sales transaction, and if so, providing a user display of any such marketing items. Where multiple ones of sales promotion marketing items are determined to be applicable to the sales transaction, the method includes prompting for and receiving user-initiated input that indicates whether or not each of the multiple ones of the marketing items is valid for the sales transaction. The method includes calculating a price for the sales transaction using the valid ones of the marketing items and predefined condition information among the valid ones of the marketing items.

In various implementations of the method of processing an electronic sales order using electronic sales promotion information, one or more of the following additional features may be used. The multiple ones of the marketing items are of a type that impacts a price that a customer is charged for a product. In this case, at least one and perhaps more of the multiple ones of the marketing items may be a sales discount. The condition information may be the information set forth above and in the following detailed description.

In other aspects, this document describes computer program products tangibly embodied in information carriers such as program memory and random access memory. The computer program products include instructions that when executed by a processor perform operations for creating electronic sales promotion information as described above and in the following detailed description, and for processing an electronic sales order using electronic sales promotion information as described above and in the following detailed description. In addition, this document describes various computing systems for creating electronic sales promotion information as described above and in the following detailed description, and for processing an electronic sales order using electronic sales promotion information as described above and in the following detailed description.

The methods, computer program products and systems described in this document offer one or more of the following benefits. Multiple sales promotion items may be easily and flexibly designed, used, and controlled. This may be done in a manner that prevents potentially inconsistent promotions from being created, or if created, from being applied to the same sales transaction.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary system for obtaining sales promotion information for use in subsequent electronic sales order processing.

FIG. 2 is a block diagram of the exemplary system of FIG. 1 including a customer relationship management system and an enterprise resource planning system.

FIG. 3 is a flow chart showing exemplary steps for implementing marketing item planning.

FIG. 4 is a flow chart showing exemplary steps for processing an electronic sales order.

FIG. 5 is an exemplary graphical user interface for displaying multiple sales promotions associated with an electronic sales order.

FIG. 6 is a schematic diagram of a generic computer system.

Like reference symbols in the various drawings indicate like elements.

### DETAILED DESCRIPTION

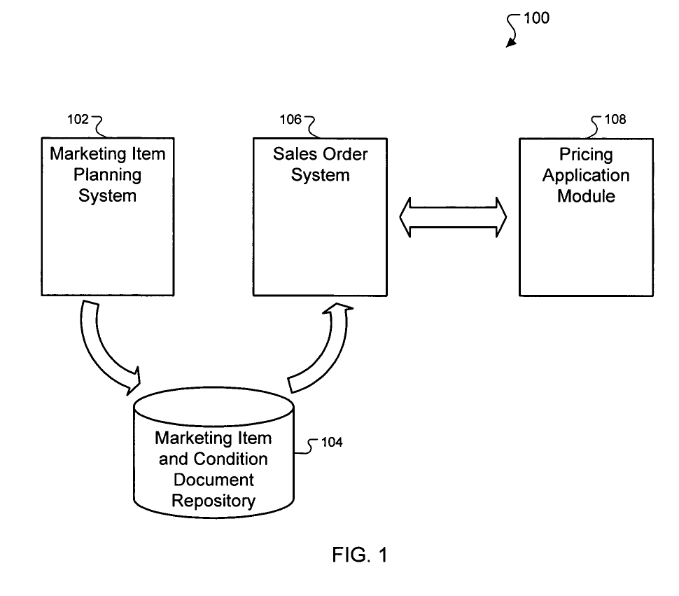

FIG. 1 shows an example distributed computing system 100 that is capable of creating and using multiple sales promotions (which in this document may at times be referred to as marketing items) that each may have a bearing on a price that a customer is charged for a product. The system 100 makes the multiple sales promotions manageable and gives users who design the sales promotions insight into all of the applicable promotions for a particular product and their interrelationships. In addition, the promotions planning process determines conditions that will later be used in other computing processes, such as a pricing process that may be executed during a sales order process or during an invoice preparation process.

Generally, the FIG. 1 system 100 includes a marketing item planning computing system 102 that may be used by marketing planners to design and enter sales promotion information, and to create conditions for situations where multiple promotions may apply to sales of the same product. As mentioned previously, using this marketing planning system 102, multiple sales promotions, or marketing items, may be designed and entered that apply to the same product. The system 100 also includes a marketing item and condition document repository 104, where electronic documents containing the promotions and condition information mentioned above may be stored so that the condition information may be accessible to other computing systems and processes that use marketing item information and condition information relating to marketing items. The system 100 includes one such system that makes use of marketing item and condition information, and that system is a sales order computing system 106. Finally, the simplified diagram of FIG. 1 shows that the system 100 includes a pricing application computing module 108 that is used, or called, by the sales order system 106 to compute a price for a product, and may takes into account the marketing item and applicable condition information.

In the context of the present description, the sales promotion information discussed above refers to marketing items such as a sales discount, a rebate, a sale price, or a free cost, to name a few examples. More generally, the marketing items are of a type that may have a bearing on a price that a customer is charged for a product. The sales promotion information also includes information about the sales promotion marketing items, such as a start and end date for a discount, products that apply to a rebate, or specific customers that are offered a reduced sales price. In addition, the sales promotion information includes conditions that will apply to marketing items when multiple marketing items are applied to the same sales order. Such conditions may be, for example, a cap, or maximum, on the overall percentage that a product may be discounted or a sales price that is exclusive from other marketing items (in other words, a minimum price that cannot be further discounted regardless of additional price reduction marketing items being applicable to the sale). The marketing item planning (MIP) system 102 in the FIG. 1 example obtains the sales promotion information. To do this, the MIP system 102 may receive user-initiated input to add a new marketing item. The user-initiated input may also include an association between the new marketing item and sales of a selected product. In response to the entry of a new marketing item for a selected product, the MIP system 102 determines if one or more marketing items have already been associated with sales of that selected product. If so, then the MIP system 102 provides to the user a display of the previously associated marketing items.

The user may review the previously associated marketing items to determine if any conflicts exist between the previously associated marketing items and the new marketing item. For example, if the previously associated marketing items combine to form a discount of 40 percent and the new marketing item has a discount of 70 percent, this may present a conflict. It is most likely that the user does not intend to give the buyer an overall discount of 110 percent. In this case, the user may place conditions on the application of marketing items associated with sales of a selected product.

As an example of sales promotion marketing items, a company selling wool stockings may offer the wool stockings at a discounted price during warm periods as the demand for the wool stockings drops, such as a 10 percent discount during summer months. The information regarding the new marketing item, in this example, may include dates during which the climate is warm and the particular stockings to which the discount applies. Additionally, the company may offer a discount to purchasers that buy the wool stockings in a bulk amount. For example, there may exist a marketing item associated with the wool stockings that includes information regarding the minimum number of wool stockings purchased in order to receive the bulk discount, such as a 10 percent discount when purchasing at least 100 pairs of stockings. Further, another bulk discount may apply if the number of stockings purchased meets a second minimum amount of stockings, such as a 20 percent discount when purchasing at least 200 pairs of stockings.

As mentioned previously, to account for a situation where multiple sales promotion marketing items apply to the same product sales transaction, the marketing item planning (MIP) system 102 may receive a user input that contains information regarding conditions. In the wool stocking example, there may be condition information entered regarding the wool stocking seasonal discount and the wool stocking bulk discounts. The MIP system 102 may receive a user input identifying an associated marketing item as exclusive, indicating that if the associated marketing item applies to a sale, then no other associated marketing items will be applied. For example, the user may identify both of the bulk discounts as being exclusive. The MIP system 102 may receive a user input containing a maximum discount, such as a 20 percent discount overall on the purchase of the wool stockings. One associated marketing item may be identified as a primary marketing item. In some implementations, the primary marketing item may be attributed the effects of all associated marketing items for the purposes of analytical reporting. As discussed previously, the MIP system 102 stores the information regarding the new marketing item and the conditions among the associated marketing items in a marketing item and condition document repository 104.

The sales order system 106 performs processes in conjunction with electronic sales transactions. For example, when a sale of a product occurs, the sales order system 106 retrieves any marketing items associated with the product and conditions associated with the marketing items. The sales order system 106 may provide the associated marketing items and the conditions associated with the marketing items to a pricing application module 108. The pricing application module 108 may use information about the product, the associated marketing items, and the conditions associated with the marketing items to determine a price of the product. The sales order system 106 may receive the price of the product from the pricing application module 108. The sales order system 106 may use the product price to complete the sale of the product.

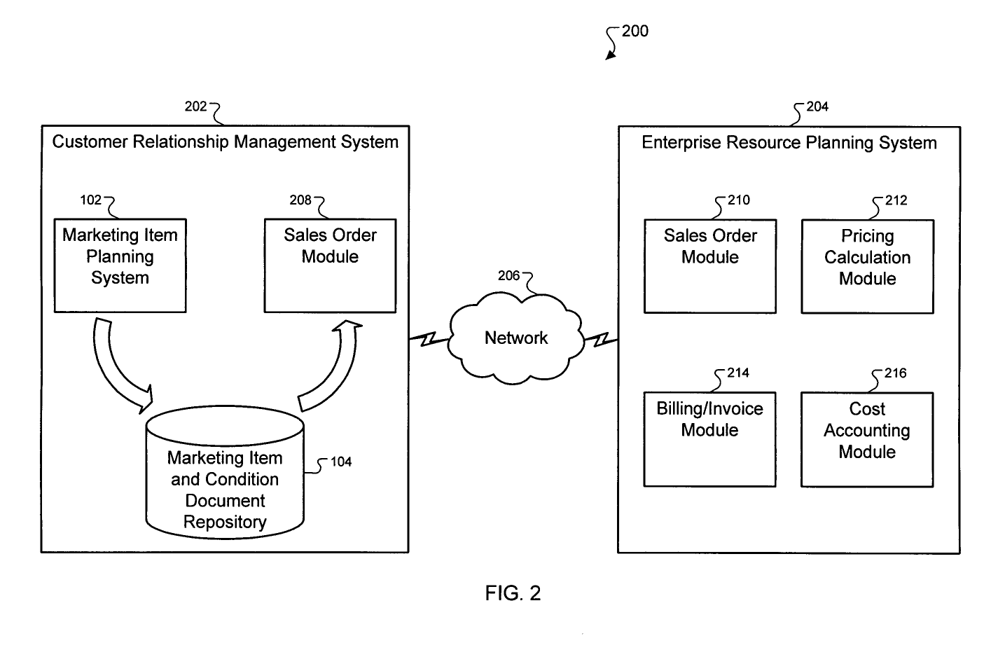

FIG. 2 shows how the computing components shown in FIG. 1 may be implemented in an enterprise computing system 200. The system 200 includes a customer relationship management (CRM) computing system 202 and an enterprise resource planning (ERP) system 204. Generally, a CRM system is one that performs computing processes related to customer interactions, and may involve marketing functions, sales activities, and service functions. ERP system are generally systems that are used for operational planning and administration, and for optimizing internal business process. The CRM system 202 and the ERP system 204 in the FIG. 2 example are in communication via a network 206, such as a local area network or the Internet. In the FIG. 2 example, the CRM system 202 includes the MIP system 102, the marketing item and condition document repository 104, and a sales order module 208. The ERP system 204 also includes a sales order module 210, and includes a pricing calculation module 212, a billing/invoice module 214, and a cost accounting module 216. Both the CRM sales order module 208 and the ERP sales order module 210 may make calls to, and hence use, the ERP system's price calculation module 212. The CRM system 202 and the ERP system 204 are capable of processing sales transactions, such as the wool stockings transaction described above.

The sales order module 210 is capable of receiving electronic information in connection with a sales transaction. The electronic information may indicate a particular product being sold to a customer, such as wool stockings. The sales order module 210 also is capable of determining if any marketing items are applicable to a sales transaction, such as a discount price or a rebate. If there are any marketing items applicable to a sales transaction, the sales order module 210 is capable of presenting the applicable marketing items to a user. In addition to automatically determined marketing items, the user may input a marketing item manually during the processing of the sales transaction, for example, if the customer presents a sales agent with a couple.

To account for a situation where there are multiple applicable marketing items, the sales order module 210 is capable of prompting a user for an input indicating whether each of the applicable marketing items is valid for the sales transaction. The pricing calculation module 212 is capable of accessing and receiving the indicated marketing items and the sales transaction information. The pricing calculation module 212 also and is capable of accessing and receiving the condition information. The pricing calculation module 212 is capable of using the information regarding the marketing items, the sales transaction, and the conditions, and from that determining a price to charge the purchaser for the sales transaction.

The billing/invoice module 214 may receive the pricing information, such as the overall price and any discounts from the marketing items, and from that may create a bill or invoice that may be sent to a purchaser. In addition, the cost accounting module 216 may receive the pricing information from the pricing calculation module 212. In another implementation, the cost accounting module 216 may calculate the pricing information itself using the information regarding the marketing items, the sales transaction, and the conditions. Using pricing information for sales transactions and other business information, the cost accounting module 216 may be capable of analyzing the costs to the company for providing products or services. For example, the costs may go up as more marketing items are applied. The sales order module 210, or a user, may also be capable of using the cost analysis to alter the conditions for one or more marketing items.

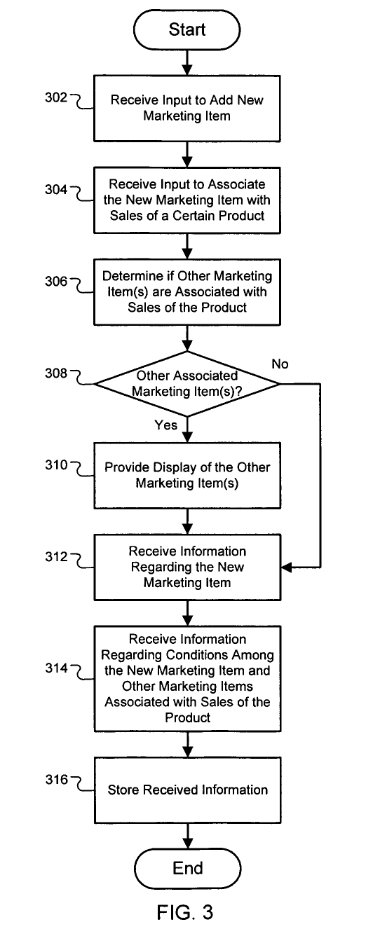

FIG. 3 depicts an exemplary process 300 for implementing marketing item planning. A processor executing instructions stored in a computer program product can perform the process 300. The may be done, for example, by a processor contained within the marketing item planning system (MIPS) 102 in the FIGS. 1 and 2 systems. The process 300 begins, at step 302, with the receipt of a user input indicating a new marketing item to be added. The marketing item may be a sales promotion, such as a sales discount, a rebate, or a free product. For example, the MIPS 102 may receive a user input indicating a new marketing item, such as a seasonal discount for a product. At step 304, a user input to associate the new marketing item with sales of a certain product is received. For example, the MIPS 102 may receive a user input indicating that the seasonal discount is associated with a particular wool stocking product. The association input may be separate from the new item input or they may be combined.

It is then determined, at step 306, if other marketing items are associated with sales of the product. If, at step 308, one or more other marketing items are determined to be associated to sales of the product, then the process 300 proceeds to step 310 where the user is provided with a display of the other marketing items. For example, the MIPS 102 may determine that there are two other marketing items associated with the wool stockings, such as the two bulk discounts. The MIPS 102 provides the user a display of the two bulk discounts. The user may use the information presented about the other associated marketing items to identify desired conditions governing the application of the new marketing item and the existing associated marketing items to sales of the product.

If, at step 308, there are no other marketing items associated with sales of the product or the other marketing items have been displayed, at step 310, then the process 300 proceeds to step 312 where information regarding the new marketing item is received. At step 314, information regarding conditions among the new marketing item and any other marketing items associated with sales of the product is received. For example, the MIPS 102 may receive a user input indicating the dates during which the seasonal discount on the wool stockings is valid or a maximum discount that may be incurred on the wool stockings from all marketing items associated with sales of the wool stockings.

The received condition information is stored, at step 316. For example, the MIPS 102 may store the valid dates for the seasonal wool stocking discount and the maximum wool stocking discount conditions in the marketing item and condition document repository 104.

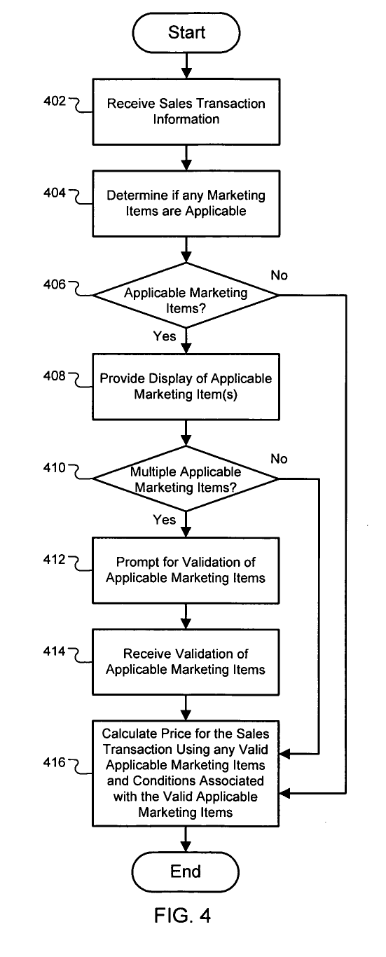

FIG. 4 depicts an exemplary process 400 for processing an electronic sales order. A processor executing instructions stored in a computer program product can perform the process 400. The may be done, for example, by a processor contained within the sales order system 106 of the FIG. 1 system or the sales order systems 208 and 210 of the FIG. 2 system.

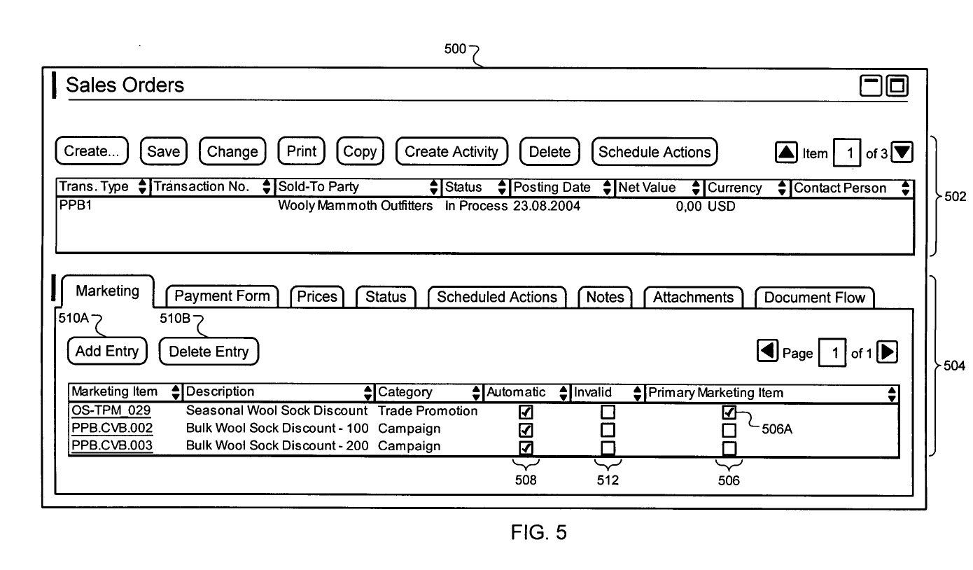

The process 400 begins, at step 402, with the receipt of sales transaction information. For example, the sales order module 210 may receive a user input indicating a purchase by a buyer, such as a purchase of 250 wool stockings. At step 404, it is determined if any marketing items are applicable to the sales transaction. For example, the sales order module 210 may determine from the information in the marketing item and condition document repository 104 that the seasonal wool stocking discount, the 100 wool stocking bulk discount, and the 200 wool stocking bulk discount are applicable to the wool stockings purchase. If, at step 406, one or more marketing items applicable to the sales transaction exist, then the user is provided with a display of the applicable marketing items, at step 408. For example, the sales order module 210 may present to the user the graphical user interface (GUI) 500 shown in FIG. 5.

FIG. 5 shows an exemplary graphical user interface (GUI) 500 that may be displayed on a visual display device. The GUI 500 presents to a user, marketing items applicable to a sales transaction. The GUI 500 may present one or more marketing items, or sale promotions, applicable to the sales transaction. The GUI 500 includes a sales transaction area 502, which may present sales transactions. In addition, the GUI 500 includes a marketing item area 504 that presents marketing items applicable to the sales transaction presented in the area 502. Here, the area 502 presents a wool stockings sales transaction to a particular company. The area 504 presents the marketing items applicable to the purchase, including the seasonal wool stocking discount, the 100 stocking bulk discount and the 200 stocking bulk discount.

The sales order module 210 may use other marketing item information, such as a priority of each marketing item (not shown), to determine a primary marketing item. The sale order module 210 may present the results of the determination using checkboxes 506. Here, a checkbox 506A indicates that the seasonal wool stocking discount is the primary marketing item.

The sales order module 210 may indicate using checkboxes 508 whether a marketing item was automatically applied by the sales order module 210 or manually applied by a user. For example, a user may initiate the addition of a new marketing item during the sales transaction process 400 by selecting an input control 510A, or the user may remove a marketing item by selecting an input control 510B. Marketing items identified as automatic, for example, may be created during the marketing item planning process 300 by the MIPS 102 and determined to be applicable during the sales transaction process 400 by the sales order module 210.

Referring again to FIG. 4, if, at step 410, there are multiple applicable marketing items, then the user is prompted to validate the marketing items, at step 412. For example, the sales order module 210 may present the GUI 500 where the user may identify using checkboxes 512 marketing items that are invalid with respect to the current sales transaction. The marketing item validation input is received, at step 414.

When the validation has been received, if there were no applicable marketing items at step 406, or if there were not multiple applicable marketing items at step 410, then the process 400 proceeds to step 416, where the price of the sales transaction is calculated. Any valid applicable marketing items determined in the previous steps and condition information associated with the marketing items may be used to calculate the price of the sales transaction. For example, the pricing calculation module 212 may calculate the price of the wool stocking transaction. The pricing calculation module 212 may use a marketing item condition associated with the marketing items, such as a maximum discount of 30 percent on wool stocking transactions.

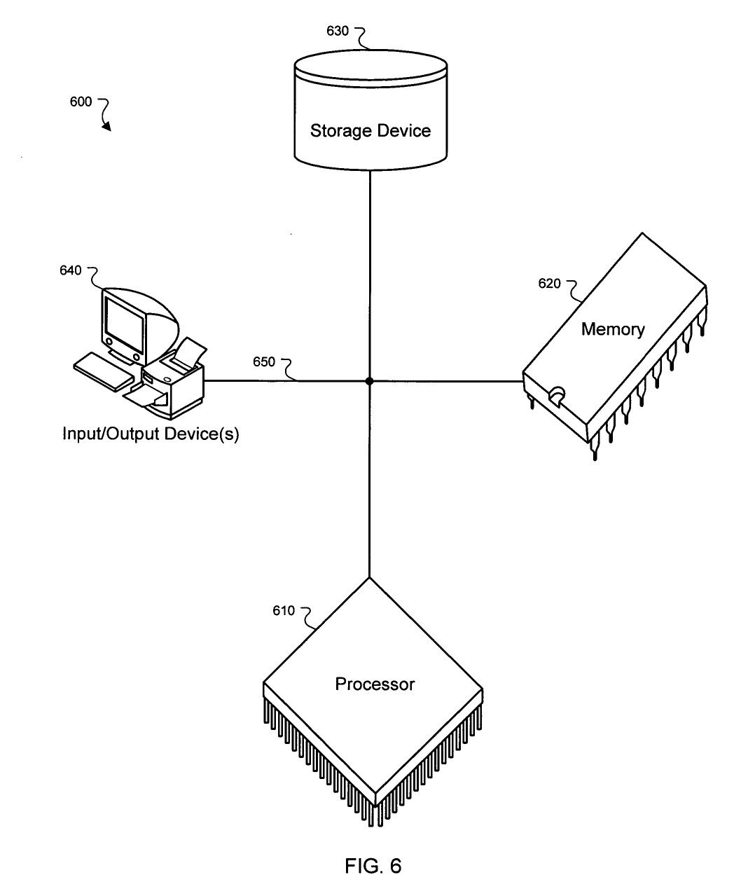

FIG. 6 is a schematic diagram of a generic computer system 600. The system 600 can be used for the operations described in association with methods 300 and 400 according to one implementation. For example, the system 600 may be included in either or all of the CRM system 202 and the ERP system 204, or subsystems, such as the MIPS 102.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the CRM system 202 and the ERP system 204, may be implemented within the same computer system or the sales transaction may originate from the sales order module 208 within the CRM system 202.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented process for creating electronic sales promotion information, the method comprising:
receiving user-initiated input to generate a sales promotion marketing item and associate the generated marketing item with sales of a selected product;
if one or more sales promotion marketing items have been previously associated with sales of the selected product, providing a user display of the previously associated marketing items to guide user design of conditions among the newly associated marketing item and the one or more previously associated marketing items; and
receiving user-designed condition information and electronically storing the received condition information for use in a subsequent computer-executed process.

2. The method of claim 1, wherein the subsequent computer-executed process is a pricing process executed in conjunction with a sale of the product.

3. The method of claim 2, wherein the newly associated and the one or more previously associated sales promotion marketing items are of a type that impacts a price that a customer is charged for a product.

4. The method of claim 3, wherein at least one of the associated sales promotion marketing items is a sales discount.

5. The method of claim 3, wherein the received condition information comprises an identification of a one of the newly associated and the previously associated marketing items that will serve as a primary marketing item that is attributed the effects of all other of the associated marketing items for purposes of analytical reporting.

6. The method of claim 3, wherein the received condition information comprises information that determines what is to happen when it happens that multiple ones of the associated marketing items are determined during the pricing process to apply to a product sale.

7. The method of claim 3, wherein the received condition information comprises information that identifies a maximum price discount in an event that multiple ones of the associated marketing items provide a price discount and are determined during the pricing process to apply to a product sale.

8. The method of claim 3, wherein received condition information comprises information that identifies a discount escalation procedure to be followed in an event that multiple ones of the associated marketing items provide a price discount and are determined during the pricing process to apply to a product sale.

9. The method of claim 1, further comprising receiving user-initiated input about the newly associated sales promotion marketing item comprising a validity period for the marketing item and applicable products to which the newly associated sales promotion marketing item applies.

10. The method of claim 9, wherein the user-initiated input about the newly associated sales promotion marketing item further comprises an identification of customers for whom the newly associated marketing item applies.

11. A computer-implemented process for processing an electronic sales order using electronic sales promotion information, the method comprising:
in connection with the receipt of electronic information in connection with a sales transaction, determining if any sales promotion marketing items are applicable to the sales transaction, and if so, providing a user display of any such marketing items;
where multiple ones of sales promotion marketing items are determined to be applicable to the sales transaction, prompting for and receiving user-initiated input that indicates whether or not each of the multiple ones of the marketing items is valid for the sales transaction; and
calculating a price for the sales transaction using the valid ones of the marketing items and predefined condition information among the valid ones of the marketing items.

12. The method of claim 11, wherein the multiple ones of the marketing items are of a type that impacts a price that a customer is charged for a product.

13. The method of claim 12, wherein at least one of the multiple ones of the marketing items is a sales discount.

14. The method of claim 12, wherein the predefined condition information comprises an identification of a one of the marketing items that has been predefined to serve as a primary marketing item that is attributed the effects of all other of the associated marketing items for purposes of analytical reporting.

15. The method of claim 12, wherein the predefined condition information comprises information that determines what is to happen in a case where multiple marketing items are determined to apply to a sales transaction.

16. The method of claim 12, wherein the predefined condition information comprises information that identifies a maximum price discount in an event that multiple marketing items are determined to apply to a sales transaction.

17. The method of claim 12, wherein the predefined condition information comprises information that identifies a discount escalation procedure to be followed in an event that multiple marketing items are determined to apply to a sales transaction.

18. A computer program product tangibly embodied in an information carrier and comprising instructions that when executed by a processor perform operations for creating electronic sales promotion information, the operations comprising:
receiving user-initiated input to generate a sales promotion marketing item and associate the generated marketing item with sales of a selected product;
if one or more sales promotion marketing items have been previously associated with sales of the selected product, providing a user display of the previously associated marketing items to guide user design of conditions among the newly associated marketing item and the one or more previously associated marketing items; and
receiving user-designed condition information and electronically storing the received condition information for use in a subsequent computer-executed process.

19. The computer program product of claim 18, wherein the subsequent computer-executed process is a pricing process executed in conjunction with a sale of the product.

20. The computer program product of claim 19, wherein the newly associated and the one or more previously associated sales promotion marketing items are of a type that impacts a price that a customer is charged for a product.
